(19) United States
(12) Patent Application Publication
(10) Pub. No.: US 2017/0193638 A1
(43) Pub. Date: Jul. 6, 2017

(54) SYSTEM AND METHOD FOR CONTROLLING DYNAMIC RANGE COMPRESSION IMAGE PROCESSING

(71) Applicants: Kevin Patrick GRUNDY, Fremont, CA (US); Brian HOFSTETTER, Scotts Valley, CA (US)

(72) Inventors: Kevin Patrick GRUNDY, Fremont, CA (US); Brian HOFSTETTER, Scotts Valley, CA (US)

(21) Appl. No.: 15/510,634

(22) PCT Filed: Sep. 11, 2015
(86) PCT No.: PCT/US15/49843

§ 371 Date: Mar. 10, 2017

Related U.S. Application Data
(60) Provisional application No. 62/049,187, filed on Sep. 11, 2014.

(51) Int. Cl. G06T 5/00

(52) U.S. Cl. CPC G06T 5/007; G06T 2207/10024

(57) ABSTRACT

The present invention is directed to a method for adjusting luminance of one or more digital images for use by a client connected to a network. The method includes the step of selecting by an operator one or more pre-determined input parameters for a dynamic range compression (DRC) processor that adjusts the luminance of the one or more digital images for use by the client display. The method also includes the step of generating one or more adjusted images by said DRC processor, wherein said one or more adjusted images comprise an image asset. The method further includes the step of loading the image asset to one or more storage devices.

### CROSS REFERENCE TO PRIOR APPLICATIONS

This application claims priority from U.S. Provisional Application No. 62/049,187 filed Sep. 11, 2014, under 35 U.S.C. Section 119(e).

### FIELD AND BACKGROUND OF THE INVENTION

1. Field of the Invention

The present invention relates to the field of image processing.

2. Discussion of Related Art

In the past, when a film (movie) was created, great care was exercised by the artisans in Hollywood to set the lighting and the processing of the film to ensure viewers would perceive the intent of the captured scenes. Furthermore, when such a film was transferred to video (e.g., using a Telecine), great care was again taken to transfer the film into video formats for viewing on televisions. The artisans performing these conversions had the advantage of the ubiquity of televisions. Most televisions were constructed using cathode ray tubes with substantially identical performance features and limitations regardless of the manufacturer. In addition, the broadcast of the television signal was standardized with predictable performance. Furthermore, the location of televisions within homes was well understood and provided the artisans a cogent understanding of ambient viewing conditions. Therefore, the artisans could effectively provide their transformations from film to video with a homogenous target viewing experience.

In today's world of viewing videos, the epoch of homogenous viewing displays are gone. Televisions are not all cathode ray tubes; in fact, cathode ray tubes have been almost completely replaced by other display means and are virtually obsolete in the present-day consumer marketplace. Front projection displays on reflective screens (not unlike movie projection in traditional theaters) are commonly used in courtrooms and churches to project images onto large screens. Plasma and LED screens are common for computer screens, flat screen TVs, and cellular telephone screens. Massive billboards using very bright LEDs can produce a viewable picture in broad daylight. And new technologies, from 3-D movies to holographic projection continue to introduce new variables to video displays and the perception of images. De-interlacing, screen refresh rates, back-lighting techniques, and an increasing array of technical options have replaced the homogeneity of first generation televisions with an ever-increasing galactic array of viewing options. Each of these typically introduces unique effects in image that is displayed, and the perception of that image by a consumer or viewer.

Another variation in viewing experience is created through the wide variety of diverse environments. In 1960, a TV was viewed indoors, where the ambient background light was both predictable and largely controllable. But today, one may access a sporting event on a small-screen cellular telephone in the glare of a ski-slope at noon, or watch a movie from a laptop computer in the middle of the night on a sailboat. It is nearly impossible to create a video with attributes which optimize viewing in such a wide assortment of ambient lighting conditions.

Another variation in picture quality has been created by the intersection of bandwidth limitations and image compression. In the past several decades, video compression and delivery technologies have made it possible to deliver and view videos on an increasing number of digital display devices. These advancements have been enabled by exponential increases of digital processing power underlying advancements in silicon processing improvement. Great strides have been made in both spatial and temporal video algorithms for compressing the amount of data required for digital video recording and transmission. Different video compression and processing techniques produce video files of significant different file sizes, imposing widely different demands on a network bandwidth. This variation can become dispositive in streaming video applications. A superior video optimized for a given set of variables may be virtually useless if the digital data stream exceeds the capacity of a data channel. Industry has made substantial progress in moving towards an adaptive video compression methodology to maximize the file size of a streaming video without overwhelming the bandwidth of a network. This adaptive video compression, however, has not kept pace with the full scope of potential demands by a wide variety of digital clients, and the full range of potential compression algorithms.

Moreover, the image processing is usually done exclusively with a view toward reducing bandwidth, without any consideration of other factors which might influence image quality. The exponential proliferation of display formats and technologies (and other variables) has outstripped the progress made in image processing.

Psychological studies have demonstrated that human perception of images on paper or canvas differs from the perception of real-world objects, and the human perception of digital images from display screens differs from paper or canvas. Although image enhancement has been utilized for many years with the printed page, psychological studies have demonstrated that human perception of display screen images (as well as forward-projected images) create novel problems of human perception. The “psycho-dynamics” of human perception and ambient conditions must be taken into account when attempting to render the most realistic image. Digital processing can be used to achieve the greatest realism in a digital image. However, owing to the variations in display devices and ambient conditions of the display, there can be no single optimization as in the early days of television.

A major constituent of providing realistic rendering of an image on a display is driven by how the image luminance is depicted on a display. The luminance profile necessary for the most realistic depiction may vary from one display device to another, or devices set in different ambient lighting conditions. For example, display devices being observed in high ambient light may yield a more realistic picture if the luminance profile is “stretched” or spread out (increasing the relative luminescent intensity between the low luminance pixels and the high luminance pixels.) Conversely, in low ambient light viewing conditions, the luminance profile of an image may be enhanced by de-emphasizing or compressing the luminance profile. Additionally, it has been discovered that, when real-world pixels adjacent each other show a wide variation in luminance, an image may be rendered more realistic by compressing the variation between a localized group of adjacent pixels. This approach is generally referred to as Dynamic Range Compression (DRC). Digital processing of an image is, therefore, often counter intuitive.

A DRC image processing method is taught by Moredechai Sheffer in U.S. Pat. No. 6,091,164 entitled “Method for Automated High Speed Improvement of Digital Color Images” that issued on May 31, 2005, incorporated herein by reference. Sheffer teaches an innovative method of image luminance processing utilizing light and dark computations. The aggressiveness of both the light and dark processing are controlled by fixed coefficients, K and X. These X and K settings affect how the processing improves not only the intelligibility of the resulting image but also the overall energy required to present a processed image on different display devices.

Sheffer teaches methods for the improvement of images and is designed for a single setting with a targeted display. As noted above, however, in today's world, there are millions of display clients having a wide range of performance and use characteristics, in a wide range of settings, from ambient lighting to bandwidth availability. Moreover, some devices (or settings), are power hungry and will drain a battery very quickly if a highly luminescent display is run off the battery.

### BRIEF SUMMARY OF THE INVENTION

The present invention makes use of controlling dynamic range compression (DRC) processing of images as an end-to-end managed system. FIG. 1 is a block diagram for a DRC processor that includes certain feature as taught by Sheffer. FIG. 2 is a block diagram directed to an embodiment of the invention incorporating a DRC Processor 1 that includes features taught by Sheffer. Digital Image 13 is supplied and is normalized before being introduced to separate dynamic range compression processors 76 and 77. A Balance Filter 78 is used to combine the output of the compression processors. A final image is produced and displayed on Display 19 by a Color Filter 79 which utilizes data from the Balance Filter 78, the input data 16 and the original set of color matrices 80 (C₁(i,j), C₂(i,j), . . . Cₘ(i,j)), where Cₙ(i,j) is the intensity value of the image in the nth color component, at the pixel, whose coordinates are presented on one or more Displays 19 at row i and column j. Sheffer addresses different displays in terms of full-scale computation.

Display device-type (e.g., plasma, LED, forward (theater type) projection onto a screen, and other device variables) yield a different appearance for identical dynamic range compression of an image. Ambient light affects the appearance of an image on a screen. The incoming image is adjusted through Dynamic Range Compression to conform to the parameters governing the display of the image. In addition to conditions in which the display device is set (device type and ambient light), network bandwidth affects image quality. Dynamic Range Compression can be modified to reduce the file size, thereby accommodating bandwidth limitations of a transmission path. Because there is not one single “bandwidth” parameter, DRC must be flexible to accommodate different bandwidth limitations, just as it must be flexible to optimize an image displayed in different ambient light conditions or on different device-types. Finally, in circumstances in which a video is being viewed on battery power, battery limitations may require enhanced luminance attributes if the battery is to last to the end of the movie. Dynamic Range Compression can advantageously be used to provide the optimal image under the limitations of reduced power consumption. These and other variables are advantageously addressed by Dynamic Range Compression. Multiple digital DRC Profiles are advantageously generated to satisfy a great diversity of circumstances as discussed above, as well as other variables.

Sheffer, however, does not address the need to provide for DRC processing according to a variety of different parameters (discussed below in reference to the embodiments) which commonly affect the perception of an image. Furthermore, while Sheffer teaches a DRC methodology for a sequence of digital color images or frames, the proliferation of video displays configured to depict moving images (sequences of single images) necessitates more variegated signal processing measures to optimize the video displays ubiquitously used on billions of devices world-wide. The present invention therefore provides a method and apparatus for adjusting the parameters of Dynamic Range Compression and other digital image enhancement techniques for still and moving pictures and further takes into consideration the capabilities and requirements of the distribution system processing the moving images plus a wide variety of variables which affect image perception, including the type of client device, ambient viewing conditions, battery life or power limitations measured against the length of time let in a video replay, bandwidth limitations in video streaming applications, and other variables.

### BRIEF DESCRIPTION OF THE DRAWINGS

The present invention is illustrated by way of example, and not by way of limitation, in the accompanying drawings and in which like reference numerals refer to similar elements and in which:

FIG. 1 is a block diagram of one embodiment of a DRC image processing system which includes features known in the relevant art.

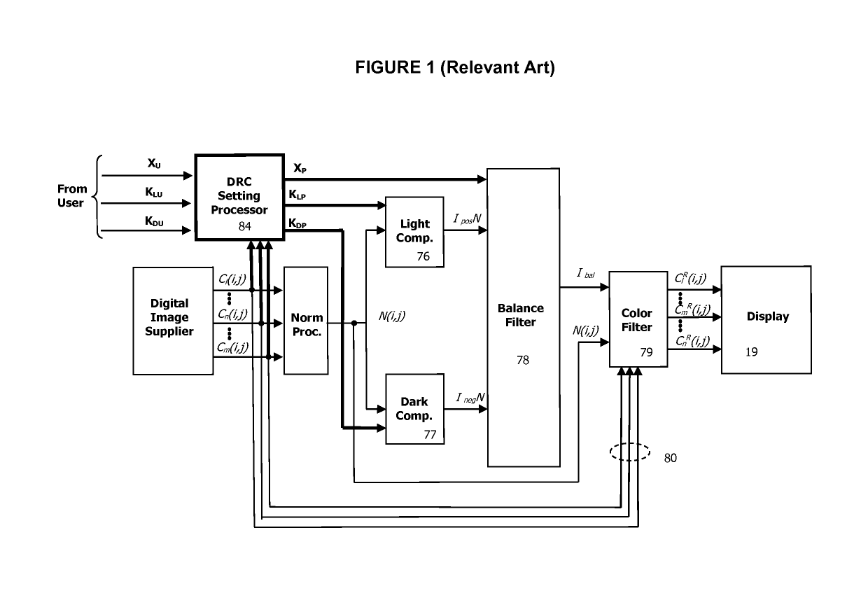

FIG. 2 is a block diagram embodiment of a DRC image processing control system for images.

FIG. 3 is diagram illustrating one embodiment of a DRC Image Asset comprising both image and DRC control data.

FIG. 4 is diagram illustrating one embodiment of a DRC Moving Image Asset comprising both image and DRC control data.

FIG. 5 is a flow diagram illustrating displaying a Moving Image which has been pre-processed with a DRC and stored for later playback on a display client.

FIG. 6 is a flow diagram illustrating displaying a Moving Image which has not been pre-processed with a DRC prior to storage. The DRC operation is conducted on the client.

FIG. 7 is a block diagram of another embodiment of a DRC image processing control system for images, similar to FIG. 2, but with an independent Client Processor and storage added.

FIG. 8 is a diagram illustrating a display screen with a virtual slide bar for increasing and reducing the power consumption of the display of an image, along with a display of the estimated battery life remaining at the setting, and the estimated time remaining in a video.

FIG. 9 is a flow diagram illustrating the creation and distribution of images for the DRC image processing control system.

FIG. 10 is a set of flow diagrams illustrating serving images for the DRC image processing control system.

FIG. 11 is a flow diagram illustrating delivering content to CLIENTs wherein CLIENTs have no capability for adjusting image luminance.

FIG. 12 is a flow diagram illustrating delivering content to CLIENTs wherein CLIENTs can adjust image luminance.

FIG. 13 is a flow diagram illustrating client data processing for the DRC image processing control system.

### DETAILED DESCRIPTION OF THE PREFERRED EMBODIMENTS

The principals and operation of the system and method for controlling dynamic range compression image processing according to the present invention may be better understood with reference to the drawings and accompanying description.

Parameters Affecting Image Perception

The perception of an image is affected by a wide variety of variables.

A first variable affecting perception of an image is the type of display device. As used herein, the “device type” comprehends a wide array of hardware, software, and operational features. Display devices vary in size from mobile phones and wrist-watch size screens to large flat screen images used on billboards for advertising. Displays vary in the number of horizontal lines, de-interlacing, screen update speed, or any other number of factors including the basic generation of photons. Each asset carries its own unique impact on the viewers experience and perception of an image. Display devices include, but are not limited to: front projection onto a reflecting screen (such as a traditional movie theater), traditional rear-projection vis-a-vis cathode ray tube (CRT), rear projection of light onto a screen, plasma screens and LED (light emitting diode screens). Digital displays also include hardware and software configured to render 3-Dimensional representations. The material from which a viewing screen is made (various glasses and plastics, etc.), and the texture, grain, allotropic form, coatings and other features of that material, can also influence the visual perception of an image projected thereon. Various hardware and software assets used for three-dimensional imaging, such as glasses to be worn by a viewer, and imaging techniques for holographic images affect the perception of an image. DRC Processing to optimize the realism of an image on one display may not optimize the image for a different display type.

A second variable affecting the perception or quality of an image is the bandwidth available in a streaming video application. Typically, the larger the digital file (total bits for a still image, or bits per second for streaming video), the higher the image quality. However, the larger the bandwidth demands of a streaming video transmission, the greater the likelihood that its transmission will exceed the demands of the network. “Bandwidth demand vs. bandwidth availability” therefore becomes a critical factor in the quality of an image under transmission. DRC processing can provide optimization of images with a view toward alleviating bandwidth limitations.

A third variable affecting the quality of viewing experience is the ambient background light. In “reflected light” images (such as reading a newspaper), the greater the intensity of ambient light, the greater the amount of light reflected from the image. Therefore, real-world images are, in effect, “self-processing.” The luminance (the amount of light reflected by the object) “keeps pace” with the ambient light level in which the object is situated. Digital displays, however, traditionally provide light from some source other than ambient light (e.g., a “backlight” of a computer monitor). When images are viewed on a display, therefore, intense ambient background light within a room can “drown-out” the image on a screen or display. Images may therefore be “processed” by a DRC processor to project sufficient light to “keep pace” with the background light. In a dark environment, a quality image can be rendered using a fairly narrow band of luminescence. In bright light, however, the “high end” of luminescence of a display needs to be significant so as to not pale into insignificance.

A fourth variable is battery life. If an image (particularly a video) is viewed on a display relying on a battery for its power needs, the length of time remaining in a video, and the energy remaining in the battery may yield alternative options. On the one hand, at an optimal DRC setting, the battery may run out before the end of the movie. Alternatively, the luminescence may be reduced below the optimal level to ensure that the battery can remain operative to the end of the movie. Luminescence is controllable through DRC processing.

DRC Processing

In this detailed description and in the accompanying drawings, specific terminology and drawing symbols are set forth to provide a thorough understanding of the present invention. In some instances, the terminology and symbols may imply specific details that are not required to practice the invention. For example, a processing block may either be implemented in software or hardware. Digital representations of numerical quantities are not limited to specific number of bit accuracies. Computations required to implement the invention are not limited to fixed or floating point or any combination thereof. Various block diagrams identified within the following description reference color components Cⱼ, Cₙ, Cₘ. These three color components are offered by way of example only, and representations of color spaces are envisioned as comprehending additional components. References to movies are interchangeable with the term video in the following descriptions. While the present invention refers to the U.S. Pat. No. 6,091,164 entitled “Method for Automated High Speed Improvement of Digital Color Images”, any other DRC methodology is allowed and anticipated.

Within this specification, luma (i.e. luminance) and chroma (chrominance) of digital images are represented by the common designations for luminance (Y) and chroma (U & V). As a consequence of the foregoing variables, the digital processing of luminance (Y) and chroma (U & V), optimally, will be different for images displayed on different devices, and will also vary as a function of bandwidth, battery life, and ambient light. Control Data dictated by these parameters are advantageously utilized in the DRC processing of an image.

For economy of description, many examples herein are directed to DRC processing of still-images. This limitation is for purposes of simplicity. The reader will appreciate that, throughout this disclosure, these processes are envisioned for application with still images and also with video files, which are often processed by an iterative process which re-calculates for each scene, or even within a single scene, the optimal DRC profile for a given set of parameters. The image profiles 2, 3, 4 are therefore envisioned as representing either DRC Profiles for processing still images, or for the processing of a video image.

DRC Profiles for Different Device Types

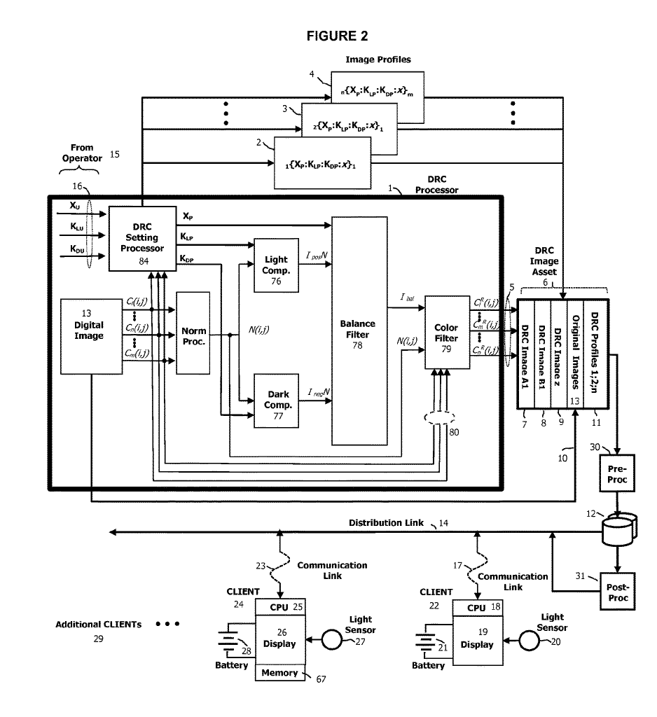

Still referring to FIG. 2, an embodiment of a DRC Processor 1 provides for the dynamic range compression of images. Dynamic Range Compression Processor (DRC Processor) 1 receives a digital input of an image 13, which may comprise a single “still” image or a video image. Video images typically comprise a sequence of still images. The digital data is processed to render the most lifelike image on a given display under a given set of circumstances. In one embodiment, an Operator 15, often referred to in the motion picture industry as a “golden eye” or colorist, views a digital image projected onto a display under certain conditions, and manually adjusts input levels of DRC Control Data 16, identified herein as X_{U}, K_{LU} and K_{DU}, to subjectively optimize the visual image under a particular set of conditions under which the operator is viewing the image. The Operator 15 is not limited to a user associated with a movie studio but can be any user who wishes to manually adjust input data 16. Alternatively, the Operator 15 may be an automated system. The DRC Control Data 16 are processed by a DRC Setting Processor 84 which generates at least one DRC Image Profile 2, 3, 4, 11 wherein DRC Image Profile 11 is the aggregate collection of DRC Image Profiles 2,3 and 4.

The Operator 15 may have to view the same image (e.g. the same video) multiple times on different devices to generate an optimal DRC Image Profile 2, 3, 4 and an optimal DRC Image 7, 8, 9 for each of the respective device-types. Each profile and image is identified by device type and other variables which were influential in the generation of an Image Profile 2, 3, 4 and its corresponding DRC Image 7, 8, 9. This may be done by segregating different file folders (or equivalent digital storage units) by device type (and other parameters), or by incorporating the device-type (and other parameters) in the title of a digital file, or a packet header used to identify the parameters associated with a particular DRC Image and its corresponding DRC Image Profile.

The Image Profiles 2, 3, 4 advantageously include time-stamps (or some other digital artifice) necessary to correlate a particular set of Image Profile data to a particular frame of a video. As used herein, reference to a single Image Profile 2, 3, 4, 11 therefore comprehends multiple data sets which are time-stamped or otherwise flagged to correlate to specific frames of a digital video file.

Concurrent with the storage of the Image Profiles 2, 3, 4, 11, each Profile is used to process a Digital Image 13 to generate a respective DRC Image 7, 8 and 9. For example, a “raw” image 13 may be processed to render an optimal image on a plasma screen in low lighting conditions (e.g., a living room with a single 60 watt bulb illuminating the room). The DRC Image Profile 2 includes data sequences for the entire video, and an optimized video, (e.g., DRC Image Asset 6 of FIG. 2) is generated. This video may be displayed on an LED screen in high background light conditions, but it has been processed to be the optimal image for a plasma screen in low light.

Throughout this disclosure, the term “raw” is used for an unprocessed image. However, embodiments are envisioned utilizing multiple processing steps. The term “raw image” can therefore refer to any image being input into a DRC processor for further processing.

The reader will appreciate that, if an image has no subjective qualitative difference when viewed under different conditions (e.g., an LED screen in low light conditions, and a plasma screen in a low-light environment), a single DRC Image Profile 2, and a single DRC Image 6 may be appropriately “tagged,” filed or otherwise designated as representing the optimal rendition in both circumstances.

DRC Processing for Different Ambient (Background Light) Conditions

As discussed above, an optimal image viewed in an environment of low ambient background light will not appear optimal in an environment of high ambient background light. Embodiments are therefore envisioned wherein the Operator 15 will view an image (e.g., a video movie) at a given intensity of background light, adjusting the inputs 16 to optimize the image in response to that particular level of ambient background light.

In a preferred embodiment, after the generation of a baseline DRC Image Profile at a first ambient light level, an algorithm will generate derivative DRC Image Profiles optimized for different levels of ambient background light, storing these DRC profiles, and appropriately identifying them by titles, tags, packet headers, or file folders, or other digital artifice which identify device type, ambient light level, and other variables. In an alternative embodiment in which an algorithm is not available to generate such derivative profiles and Image files, the Operator 15 will advantageously view the same image under alternative ambient background light conditions, generating multiple DRC Image Profiles 2, 3, 4 optimized for different levels of ambient background light. The DRC Image Profiles 2, 3, 4 and the respective DRC Images (e.g. processed videos) recorded and stored, with various digital identifiers.

Luminescence and Power Demands

If a user is viewing an image, particularly a video 7, 8, 9, on a display 19, 26 of a Client device 22, 24 using battery power 21, 28, the optimal image under the circumstances (device type, ambient background light, etc.) may exceed the remaining battery life. For example, at the optimal DRC settings, a battery may only have seventeen remaining minutes of viewing time, while there are fifty-five minutes remaining in the video. Embodiments are envisioned, therefore, wherein less luminescent options (using less battery power) are selectable by the user or Client device 22,24.

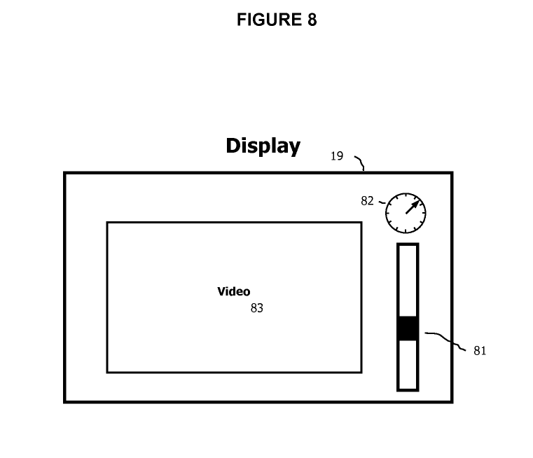

Referring to FIG. 8, in an embodiment, an interactive control 81 is displayed on the screen of a user allowing the user to increase or decrease the luminance of an image by adjusting the control. In one embodiment the control is slide bar. Concurrent with the display of an image at a new setting, a feedback icon and/or test 82 appears on the screen, indicating the battery life at the current setting. For example, at the optimal DRC setting, a message may read: “Sixteen minutes of battery remaining; fifty-five minutes to end of video.” An adjustment of the control reducing the luminance produces a message: “Twenty-seven minutes of battery remaining, fifty-five minutes to end of video.” Each adjustment alters the luminescence of the screen and the DRC settings, and is accompanied with the message describing the amount of time remaining in the battery at a particular luminescence.

In view of the potential for alternative levels of power consumption, DRC Image Profiles are advantageously generated which will consume less display power. In a preferred embodiment, after the generation of a baseline DRC Image Profile at a first and optimal display level, an algorithm generates derivative DRC Image Profiles optimized for lower display power levels, storing these DRC profiles, and appropriately identifying them by titles, tags, packet headers, or file folders, or other digital artifice which identify the DRC files and Profiles by power consumption. In an alternative embodiment in which an algorithm is not available to generate such derivative profiles and Image files, the Operator 15 will advantageously view the same image under conditions the image is to be viewed for given level of display power consumption. Because higher ambient light typically requires a brighter screen with higher power consumption, embodiments are envisioned in which DRC Videos or Profiles of varying power consumption are simply selected from Videos or Profiles generated for different ambient light conditions, thereby reducing the number of variables.

Different scenes in a movie vary in brightness and power consumption. In order to provide the best estimate of the relative power consumption of different DRC Files, during the generation of a video file, concurrent with time stamps which correlate can be used to match audio and visual portions of a movie, the video file is interlaced with period figures relating to power total consumption to that point. After the video has been completely generated, a compiler will use these values to calculate the power demands in reverse order, thereby interlacing the file with digital values of the remaining power demands of a video from any given point in the video.

Because of substantial differences in power consumption . . . from a cell-phone sized screen in a dimly lit room, to a billboard-sized screen in daylight, a standardized scale is preferably used to reference remaining power demands. During payback of a video on a particular Client 22, 24 running on battery power, the asset will preferably reference its own battery consumption relative to the values on the standardized scale, thereby enabling the client to convert the standardized values of “remaining power demands” into meaningful values relative to that asset. Alternatively, such calculations may be performed by an unrelated module, with power consumption estimates transmitted back to the client.

Bandwidth

Different DRC Images 7, 8, 9 (e.g. processed videos) comprise different file sizes. The transmission of a file is limited by the bandwidth of a network. Therefore, when the bandwidth demands of an optimal DRC Image exceed the bandwidth demands of a network, alternative files are necessary. To resolve this tension, embodiments are envisioned wherein, holding all other variables constant, alternative DRC Images 7 are generated with different file sizes in anticipation of common bandwidth restrictions and limitations. Although bandwidth limitations are most significant in applications of streaming videos, circumstances are envisioned in which bandwidth limitations affect the time to load an HTML page or a single JPEG photograph. Accordingly, the foregoing principles are intended to apply to both video images and “still” images.

An example of DRC processing for bandwidth savings is described by the generation of DRC Image Profile 2. The DRC Setting Processor 84 receives the DRC Control Data 16 input by the Operator, the image (video) produced by the operator, or some other digital values relating to thereto, which is further optimized within the DRC Setting Processor 84 to assist with traditional video encoders (e.g., MPEG2, H.264) to reduce the file size for transmission over limited bandwidth networks. When a Client 22 seeks to display the digital image 13 under conditions (e.g. a plasma screen in the same level of background light), but the preferred Image Profile 2 or DRC Image A1 7 is too large, the Client 22 identifies a smaller file (either Image Profile 3, a fully processed DRC Image B1 8) which was optimized for the same conditions, and possibly generated concurrently as described above.

The reader will appreciate that algorithms and methods for optimizing the DRC settings for luminance within the DRC Setting Processor 84 may be developed at some future time, and embodiments are envisioned wherein reduced file-size DRC Images 7, 8, 9 (processed videos) may have to be individually generated by an operator. In either event, in a preferred embodiment, these files will be identified as being optimized for a particular device, and in a particular level of ambient light.

Derivative Profiles

Specific examples were discussed above in which, concurrent with the generation of a DRC Image Profile 2, 3, 4 through Operator 15 input, derivative DRC Image Profiles are automatically generated, when possible, for alternative background light conditions. Such automatic generation of DRC Profiles 2, 3, 4 for alternative conditions is preferably utilized for every variable wherever possible by predefined algorithm. Still referring to FIG. 2, in a preferred embodiment, while an Operator 15 is generating a first DRC Image Profile 2 by adjusting inputs X_{U}, K_{LU}, K_{DU}, a Derivative Module within DRC Processor 1 (not shown), is configured to automatically generate multiple “derivative” DRC Image Profiles 3, 4. These derivative profiles may be optimized for different device-types, different ambient background light levels, different bandwidths, or different levels of power consumption. It is anticipated that derivative profiles will be more easily generated by automated processes for some conditions than for other conditions. To the extent that derivative DRC Image Profiles are not of a quality comparable to that of an image derived by a “golden eye” operator 15, derivative DRC Images 7, 8, 9 and DRC Profiles 2, 3, 4 will have to be generated manually.

The four variables listed above, i) device type, ii) ambient light, iii) bandwidth v. bandwidth demand, and iv) battery life, are cited only as examples. Any number of other variables affecting image quality may be considered, with DRC Image Profiles 2, 3, 4 and DRC Images 7, 8, and 9 being generated with a view toward optimizing an image under specific circumstances.

The number of DRC Image Profiles 2, 3, 4, or actual fully processed “movies” (DRC Images 7, 8 9) can rapidly multiply, creating storage dilemmas. Assume, for example, that the first variable, “image type,” is optimized for only four devices types: LED, plasma, CRT, and front projection (theater-type) projection. Concerning the second variable, ambient light, assume that DRC Image Profiles are optimized for five different intensity levels of ambient or background light. Concerning battery limitations and power consumption, assume, that alternative DRC Image Profiles are generated for five different levels of battery consumption. Further, assume that DRC Image Profiles are generated for seven different files sizes configured for transmission across different bandwidths. Finally, let's introduce a fifth hypothetical variable, and assume that “standard” versus “3-Dimensional” is not optimally processed as a “variation” of device type, but as a separate variable. For a high-definition movie, such as director James Cameron's 2009 Avatar, with alternative “standard” and “3-D” versions, optimal depiction of the video image across the foregoing five variables would require a data matrix of 4×5×5×7×2 yields an astonishing 1,400 different DRC Image Profiles 2, 3, 4. If the “original” digital file 13 of a major high definition motion picture such as Avatar were processed for all 1,400 settings to generate 1,400 DRC Image files (1,400 separate videos) 7, 8, 9, one can readily appreciate that a tremendous amount of digital storage is necessary for a single movie optimized for viewing under these diverse conditions.

Whether a network stores the DRC Image Profiles 2, 3, 4, the DRC Images 7, 8, 9, or both, they are advantageously identified to be easily retrieved to match a particular set of variables in which a video or other digital image is being viewed. In one embodiment, a digital header or title is advantageously attached to every digital file or file segment, identifying the “settings” or “characteristics” at which they have been optimized. According to an alternative embodiment, a matrix of storage files are identified according to their respective parameters, such that every video stored therein is configured for viewing in that set of circumstances.

Transmission of Profiles or Processed Videos

Still referring to FIG. 2, whether transmission to an end user is best achieved through transmission of a processed DRC Image 7, 8, 9 (a video specifically processed for unique conditions), or an unprocessed digital image 13 transmitted along with one or more DRC Image Profiles 2, 3, 4 depends on a variety of factors. First, if an end-user lacks the processing capability to process a DRC Image from an original image 13 and a DRC Image Profile 2, 3, 4, then, of logical necessity, only a fully processed DRC Image 7, 8, 9 can be transmitted to the user.

In instances wherein a user or client device has the capacity to process images using DRC Image Profiles 2, 3, 4, the decision to process a video image before or after transmission depends on several factors. As noted above, a single movie may have more than 1,400 different versions optimized for different viewing conditions. It may be deemed deleterious to the functionality of a network to have that many versions of a single movie stored in a distributed network at storage locations 12 scattered about the network.

Hybrid embodiments are envisioned. For example, a “new release” of a blockbuster, like Avatar, may be in such demand, that it does not overly burden the network storage to store so many versions. However, there may be very little demand for director Rex Ingram's 1921 version of The Four Horsemen of the Apocalypse. Storing 1,400 versions of The Four Horsemen may be regarded as overkill. Because orders for The Four Horsemen are comparatively rare, embodiments are envisioned wherein only the most commonly used DRC images (fully processed videos) are stored, and others are generated “on-the-fly.” However, the on-the-fly format may also be applicable to first-run movies such as Avatar. For example, projections may suggest that 99.7% of all the requests for Avatar will be satisfied through eight fully processed DRC versions. It may therefore be advantageous to simply process the remaining requests on-the-fly even for first-run movies.

Downstream Processing and Partial Processing

Embodiments are envisioned in which an entire processed DRC image 7, 8, 9 (e.g., a fully processed video) is transmitted from storage 12 to a Client 22, 24. However, alternative embodiments are envisioned in which a Digital Image 13 and one or more DRC Image Profiles 2, 3, 4 are transmitted to a client device, and the DRC processing takes place within the Client 22, 24. Consider a circumstance in which the Client 22, 24 was a flat screen TV in a family in which family members entered and exited, turning lights on and off as they came and went throughout the course of a movie. The room would be a “variable light environment.” With each flick of a light, the optimal DRC settings would change. By transmitting multiple DRC Image Profiles 2, 3, 4 to a client device, along with the original digital image 13 (or some partially processed image), DRC image processing can take place when needed, measuring ambient light in real time, instantly optimizing the viewing experience notwithstanding the changing conditions.

As illustrated in FIG. 2, embodiments are envisioned in which additional processing takes place in blocks 30, 31, which are depicted as before and after storage in digital storage member 12. The actual number of processing steps, and the logical, chronological, or geographic place of those processing steps is not limited by FIG. 2. Embodiments are envisioned for distributing the processing process across any number of steps located at any logical, chronological, network or geographic location. Example Pre Processing 30 and Post Processing 31 includes but is not limited to temporal video encoders such as MPEG 2 and H.264.

The Image Profiles denoted in FIG. 2 are shown as a set of parameters separated by colons within braces. Image Profile 2 is shown as ₁{X_{P}:K_{LP}:K_{DP}:x}₁ wherein the leading subscript “1” denotes a major unique profile. The parameters separated by colons within the braces denote the DRC parameters used for the DRC process. The parameters shown, X_{P}:K_{LP}:K_{DP}, are illustrative of one form of DRC processing, this limitation is offered only as a specific example, and is not intended to limit the utilization of other DRC parameters or algorithms in conjunction with the embodiments disclosed herein. The last parameter “x” indicates that the list of parameters may include other parameters or information associated with the DRC process. One embodiment of DRC related parameters pertains to image encoding such as JPEG or MPEG. These type parameters may provide an encoder with optimizations for the type of DRC performed on an image. The trailing subscript following the closing brace provide for further differentiation of major profiles. For each Digital Image 13, there is a DRC Image Asset 6 comprising the following collection: Original Image 13; a predetermined number of processed images, in this embodiment DRC Image A1 7, DRC Image B1 8 and DRC Image z 9; and DRC Profiles 11. The invention does not specify how the DRC Image Asset 6 is constructed or associated. Another embodiment provides for each element within the DRC Image Asset 6 to be implemented as a file with the DRC Image Asset 6 associations contained within a separate database file.

Again referring to FIG. 2, for each DRC Image 7, 8, 9 within a DRC Image Asset 6, there are corresponding DRC Profiles 2, 3, 4. As noted, in streaming video applications, alternative embodiments are envisioned wherein a processed DRC Image 7, 8 or 9 is streamed, or the Original Image 13 along with streaming profile data for processing the image after transmission. Accordingly, additional DRC Profiles 2, 3, 4 may be generated by the DRC Processor 1 and added to the DRC Image Asset 6 without a corresponding DRC processed image in the DRC Image Asset 6.

According to one embodiment, a raw image, such as Original Image 13, is transmitted to an end-user, along with a particular DRC Image Profile 2, 3, 4, and image optimization is performed somewhere “downstream,” possibly by Client 22, 24. Wherever the processing takes place, DRC processing uses a DRC Image Profile 2, 3, 4, 11 to convert the raw Digital Image 13 into a video or image that is specifically optimized for Client 22, 24 (i.e., specifically optimized for the respective displays 19, 26 of those client devices).

As shown in FIG. 2, a Distribution Link 14 supplies the DRC Image Asset 6 to Clients 22, 24. The Distribution Link 14 can be a private data network, such as, for example, from a cable TV or satellite TV operator or a public data network, such as, for example, the Internet. When the Distribution Link 14 is bandwidth constrained, transmission of a DRC Image Profile 2, 3, 4, 11 and the original image 13 would thereby increase bandwidth consumption. Server 12 may elect to distribute a more compact luminance adjusted selection of Image Asset 6 to Client 22, 24. Downstream processing is particularly valuable when a processed image (such as DRC Image Assets z, B1, A1) would consume significantly less bandwidth than transmission of the Original Image 13 and DRC Image Profiles 11 deemed necessary for displaying the optimal image. It should be noted that the entire DRC Image Asset 6 is normally not sent to a client in its entirety. Only the relevant DRC Images needed by clients are transmitted.

Again referring to FIG. 2, once a DRC Image Asset 6 is formed, it is then stored in one or more Servers 12 distributed across a network or Content Distribution Network (CDN), and then made available to Clients 22, 24 over Distribution Link 14. There are no limitations as to the number of storage devices or locations for Server 12. There are no limitations on the number of copies of a DRC Image Asset 6 stored. There are no limits to the number of Client s 22, 24 which may access the Server 12. One embodiment includes the use of a Preprocessor 30 for the purpose of encoding the image into a more compact form such as JPEG. In another embodiment, the Preprocessor 30 does not operate on the DRC Images 7, 8 or the Digital Image 13 comprising the DRC Image Asset 6.

The capability to store compressed versions of a DRC Image 7, 8 enables the savings of bandwidth through the Distribution Link 14 and the Communication Links 17, 23 associated with Clients 22, 24. Communication Links 17, 23 can be, for example, local area networks such as Wi-Fi, Bluetooth, Ethernet or Digital Subscriber Line (DSL). An image which has been DRC processed may be more likely to be compressed to a higher level while maintaining fidelity through image compression algorithms such as JPEG. Because of this increased compression, a Client 24 with a limited Communication Link 23 may choose a DRC processed image within the DRC Image Asset which has been compressed through Preprocessor 30 and made available by Server 12. This could be in contrast to a different Client 22 that may not have a limitation of the bandwidth of its Communication Link 17 and therefore may choose DRC Image A1 7 that was pre-processed differently and made available on Server 12. Clients 22, 24 will advantageously communicate with the network to identify specifics, such as ambient light, client device type, or bandwidth limitations. Another embodiment allows for the use of a Postprocessor 31 which can be used to change an image within a DRC Image Asset 6 residing on Server 12 which is then provided for Clients 22, 24.

Clients may display images 7, 8, 9, 10 and DRC profiles 11 from the DRC Image Asset 6 from storage directly in a streaming manner through the Distribution Link 14 and the Communication Link 23 or alternatively, by downloading and storing them on the clients with sufficient storage, such as Client 24 with Memory 67. Clients 22, 24 may have access to Server 12 either continuously or intermittently, as might be expected with wireless networks.

One example use case is for a Client 24 wherein the Battery 28 energy is not sufficient to provide a complete viewing of images over time due to expected battery energy consumption rates and the lack of access to an external power source. The Client 24 may, prior to disconnecting from the Server 12, choose to download and store an image from DRC Image Asset 6 which is optimized for viewing when the Display 26 is set for lowest power consumption. Alternatively, the same Client 24 may download the original Digital Image 13 from the DRC Image Asset 6 along with several DRC Profiles 11 and store them locally in Memory 67. When displaying the image, the Client 24 optionally performs the necessary DRC process on Original Image 13 according to the level energy remaining in the Battery 28. A different example has Client 22 connected to Server 12. Client 22 is in an environment where the ambient light is high and is detected by its Light Sensor 20. Client 22 accesses the DRC Image Asset 6 located on Server 12 and accesses DRC Image B1 8 which has been previously DRC processed to improve visibility in high ambient light conditions.

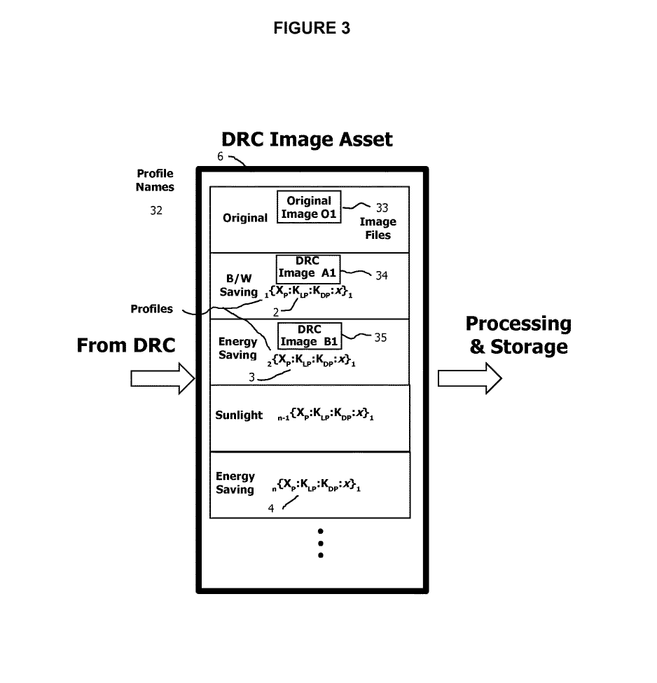

FIG. 3 illustrates one embodiment implementing a DRC Image Asset 6 as shown. Each DRC Image Asset 6 is comprised of images 33, 34, 35 and DRC Profiles 2, 3. Images can exist within the DRC Image Asset 6 without any associated profile as illustrated by the Original Image 33. Similarly, profiles may exist within the DRC Image Asset 6 that are not associated with an image such as the profile Energy Saving 4. Additionally, both images and profiles may be associated as shown with the Bandwidth (B/W) Savings 2 and DRC Image A1 34. Collectively, any arrangement of images and profiles may be associated with Profile Name 32. These Profile Names 32 provide Client 22, 24 with a direct ability to scan through a DRC Image Asset 6 to find the most efficient profile or images for display given the expected conditions.

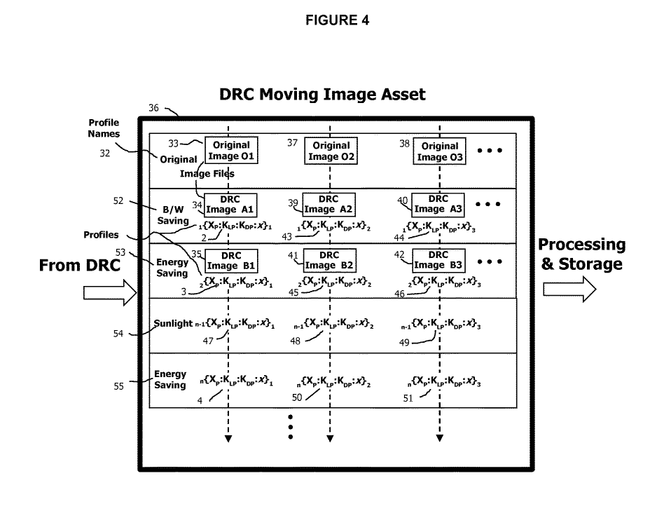

FIG. 4 illustrates another embodiment implementing a DRC Image Asset 6 as shown, that is expanded to include sequences of images, DRC Moving Image Asset 36. Unlike the single images described in FIG. 3, the images shown in FIG. 4 represent sequences of images. For example, the Original Image O1 33 is the first in a sequence of images as one might expect to be created from a motion picture or video camera. The second image in the Original profile, Original Image O2 37, is the next in the sequence for a motion picture. Clients 22, 24 with motion picture players are thus enabled to not only choose which profiles are best suited for display, but can do so from image to image. For example, while a client is playing a movie and happens to be pulling images from the B/W Savings 52 profile, changes in the battery energy level of the client may flag a need for a more efficient version of the image. Consequently, if a client's last image displayed was DRC Image A2 39 which was processed using the ₁{X_{P}:K_{LP}:K_{DP}:x}₂ 43, the client may choose for its next image, DRC Image B3 42 which was processed using the ₂{X_{P}:K_{LP}:K_{DP}:x}₃ 46 profile. In this way, the presentation of motion picture images is adaptable to prevailing client conditions on an image-by-image basis. The ability of clients to pick and choose the best image from the DRC Moving Image Asset 36 in the sequence of images according to the prevailing conditions at the client illustrates a further embodiment of the invention.

While the images presented in FIG. 4 are shown as single, the use of either Preprocessing 30 and Post processing 31 allows for the concatenation of individual images into aggregated Group of Pictures (GOP). Consequently, when Clients 22, 24 request images, they can do so as a GOP. Additionally, through either Preprocessing 30 or Post Processing 31 of DRC Moving Image Assets 36, the included images, including GOPs, may be encoded and compacted to representations that are more efficient such as H.264 MPEG encoding.

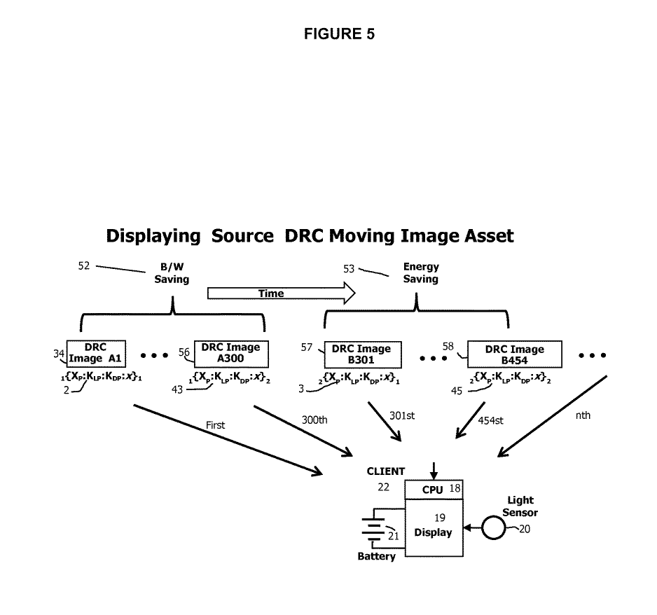

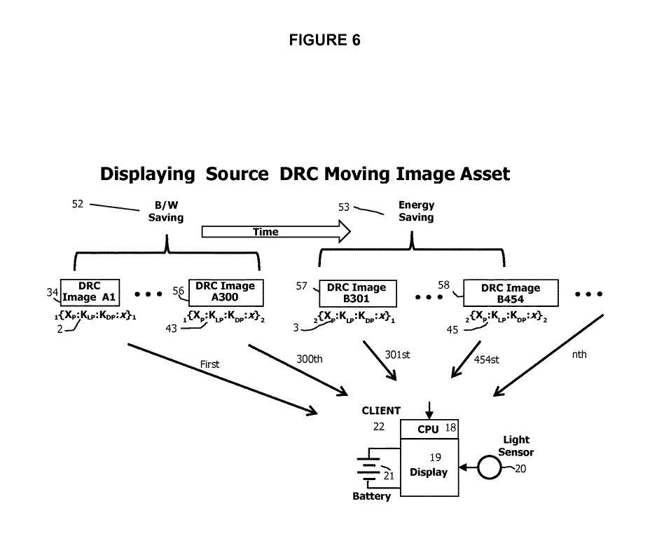

FIG. 5 illustrates a time sequence wherein the Client 22 switches from a B/W Savings profile 52, ₁{X_{P}:K_{LP}:K_{DP}:x}₂ 43, at image A300 56 to an the Energy Saving 53, ₂{X_{P}:K_{LP}:K_{DP}:x}₁ 3, profile at image B301 57. Similarly, FIG. 6 illustrates a time sequence of switching from a Sunlight 54 profile to and Energy Saving 53 profile.

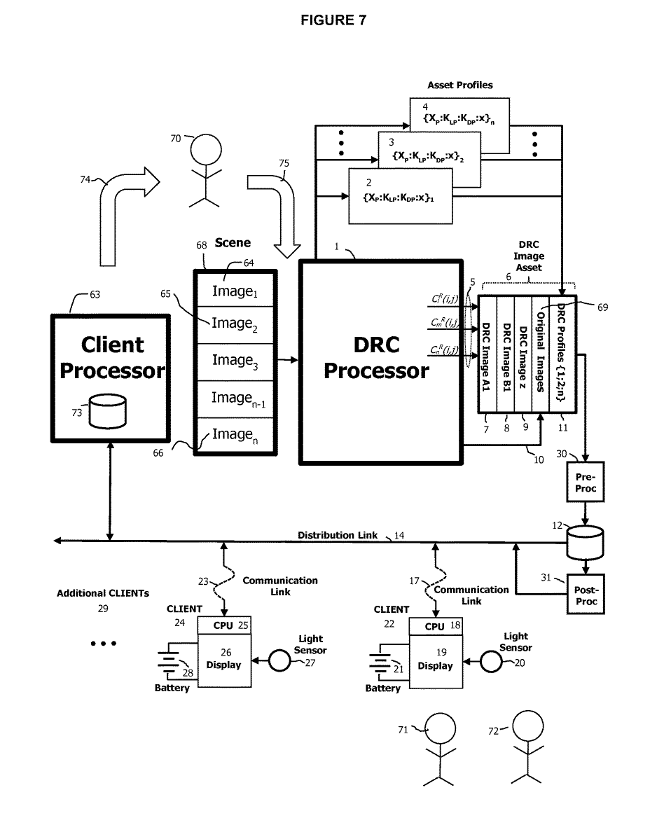

FIG. 7 is similar to FIG. 2 but includes the additional allowance for a collection of related images as a Scene 68. A Scene 68 is comprised of distinct images which are related to one another such as one might generate from a camera with a 360 degree view. It is difficult to match the luminance levels of discrete and separate imagers. Separate images 64, 65, 66 within a Scene 68 can be processed with the DRC Processor 1 and unique DRC Profiles 11 assigned as part of DRC Image Asset 6 shown in FIG. 5 or DRC Moving Image Assets shown in FIG. 6. The original images comprising a Scene 68 may be stored unprocessed in the DRC Image Asset 6 as well as DRC processed versions, such as DRC Images 7, 8, 9 and their DRC Profiles 11. A Scene 68 may also be comprised of different versions of the same image. As an example, a scene may be generated with a single camera generating different images due to lighting and camera setting changes such as aperture. By matching DRC Profiles, a panoramic 360 photograph can be rendered virtually “seamless,” an uncommon feature among such photography.

A further addition to FIG. 7 is a Client Processor 63, with Server 73, which is available for storage to Clients 22, 24 on the network. The Server 73 is used to capture use patterns among Clients 22, 24. Although clients have access to local prevailing conditions, not all clients may possess the necessary computational power or algorithmic capability to decide which DRC image or profile to use. As an alternative embodiment, clients may use a shared network accessible Client Processor 63, that accepts information from a client such as battery level, ambient light and display type, to develop and inform clients as to the best DRC image or profile to use. Clients may use their own algorithms, the Client Processor's 63 algorithms or a combination of both to make decisions regarding the use of DRC images and/or their profiles.

In a previous example, it was stated that 99.7% of all viewers of Avatar would use one of just eight DRC Profiles. FIG. 7 illustrates how this data can be compiled. The Client Processor 63 with Server 73 is available to record client selections of the images presented and their DRC settings along with prevailing conditions for the Clients 22, 24. In addition, the Client Processor 63 may utilize Server 73 to record the identity of different viewers. A Viewer 71 may use the Client 22, which results in different and separate information being stored on the Server 73 than from a different Viewer 72. This capability to collect and store use-based information comprises a system of data collection that enables system feedback for enhancing and improving DRC Image Assets 6. Collected use-based information can be extracted in step 74 by an Operator 70 and then applied in step 75 to Scenes 68 and the DRC Processor 1 thereby enhancing the DRC Image Asset 6.

User Input

While the invention includes the adjustment and control of image luminance from conditions at a client displaying images based upon prevailing conditions such as ambient lighting conditions and available energy from a batter, it also provides for user input control. FIG. 8 illustrates a Display 19 wherein a user may adjust the amount of display brightness through a user controlled Slider 81. In many display implementations the amount of power consumed is directly proportional to the brightness setting of the display. The higher the brightness of the display, the more energy is consumed. As a user varies Slider 81, the amount of energy consumed changes and at the same time, the image luminance profile displayed is varied to optimize for the amount of display brightness generated. An Indicator 82 shows the effects of the Display 19 power consumption by adjusting the display brightness. This feedback is comprised of, but not limited to, the time left for playback, energy remaining in a battery or any other indicator of the effects of adjusting Display 19.

System Sequences

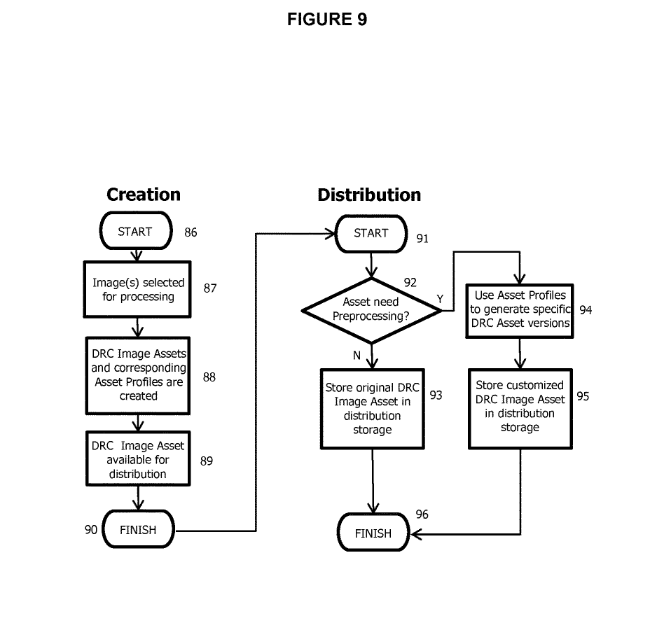

To facilitate understanding, flow diagrams FIGS. 9 through 13 are included describing general process steps comprising the creation, distribution, delivery and data collection of the DRC image processing system. In the following descriptions for FIGS. 9 through 13, the system diagram shown in FIG. 7 is assumed for references to specific components, steps and data. For example, when referring to Pre-Processor 30, this component is shown in FIG. 7. In the following descriptions for FIGS. 9 through 13, identification numbers less than 86 refer to elements comprising FIG. 7. The process flows shown in FIGS. 9 through 13 are presented as high level representative examples of general steps involved in one embodiment of a DRC image processing system.

Creation

FIG. 9 shows a flowchart sequence at steps 86-90 for creating images comprising a DRC Image Asset 6 (FIG. 7). This sequence starts at step 86 through an image selection process step 87. The selection of which image to process can be automated or guided through human interaction. Images are processed at step 88 by the DRC Processor 1 (FIG. 7) and placed into a DRC Image Asset 6 (FIG. 7). The number of DRC images 7,8,9 etc. (FIG. 7) and the types of processing of these input images generated from a single input image (i.e., Image₁ 64 in FIG. 7) can be automated or guided through human interaction. Similarly, the DRC Image Asset 6 (FIG. 7) may be populated with corresponding Asset Profiles 2,3,4 (FIG. 7) as well as an unprocessed original image (i.e. Image₁ 64 FIG. 7). A DRC Image Asset 6 (FIG. 7) may also be comprised of a sequence of images (Scene 68 FIG. 7) which represents a sequence of related images. One kind of scene is a Group Of Pictures (GOP) as defined by the MPEG standard. Once a DRC Image Asset 6 (FIG. 7) is populated with all required versions of images processed by a DRC (and original image(s)), the DRC Image Asset 6 (FIG. 7) is available for distribution at step 89. At the conclusion of the creation process, there is a DRC Image Asset 6 (FIG. 7) comprising different versions of the same input image (or sequence of images) which have been processed with various luminance profiles at step 90.

Distribution

FIG. 9 further illustrates a process, Distribution, at steps 91-96 wherein a DRC Image Asset 6 (FIG. 7) is distributed to one or more Servers 12 (FIG. 7). An example of Server 12 is a CDN used to distribute web packets to Internet devices. CDNs typically access an “origin server” wherein the source content is made available to multiple CDN storage elements which are geographically located close to clients requesting packets. When a DRC Image Asset 6 (FIG. 7) is completed and available for distribution, a CDN or similar distribution network can download the asset and store it for simultaneous access by multiple clients. However, many CDNs or distribution networks need to tailor or preprocess incoming assets to best match the delivery mechanisms they support. Examples of this are video CDNs which take a single copy of a video sequence and create multiple bandwidth bit stream versions needed for distribution on their networks. In one embodiment, obtaining and storing a DRC Image Asset 6 (FIG. 7) for later distribution is preceded by determining if the incoming DRC Image Asset 6 (FIG. 7) needs to be pre-processed before being stored. Example of this may be creating different video versions according to resolution and bandwidth similar to the manner in which HTTP Live Streaming (HLS) video is distributed. A decision is made in step 92 as to whether an incoming DRC Image Asset 6 (FIG. 7) needs to be pre-processed before storage. This preprocessing may include, but is not limited to, luminance, bandwidth, resolution or video sequences. If no preprocessing is needed, the original DRC Image Asset 6 (FIG. 7) is stored in step 93. If preprocessing is needed, then in step 94 the appropriate processing steps are taken and the results are stored in step 95.

Therefore, one embodiment of the invention is the ability to allow distribution businesses (i.e., CDNs) to customize their storage of DRC Image Assets 6 (FIG. 7) to match their target customers. A mobile CDN provider may wish to create a low bandwidth, high luminance processed versions of images within a DRC Image Asset 6 (FIG. 7) whereas a terrestrial CDN provider may provide high bandwidth, low luminance processed versions for their customers. Thus, the ability of a CDN to pre-process luminance according to the needs of CDNs is a very useful and desired embodiment of the invention.

Serving

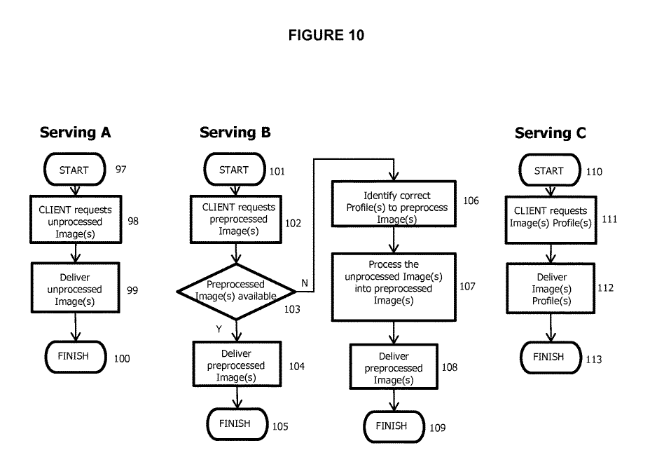

Once a DRC Image Asset 6 (FIG. 7) is stored and available to Clients 22, 24, 29 (FIG. 7) on a Server 12 (FIG. 7), serving the appropriate and desired images is controlled by the clients and their need to handle specific luminance conditions for their situation. FIG. 10 illustrates at least three different processes where a Server 12 (FIG. 7) (or a CDN) may deliver images to a client. As shown in flowchart entitled Serving A, steps 97-100 show a sequence wherein a Client 22, 24, 29 (FIG. 7) requests an image (or images) from a DRC Image Asset 6 (FIG. 7) that has not been processed for luminance. This will typically take place when a client has the ability to modify the luminance on its own during viewing.

As shown in flowchart entitled Serving B, steps 101-109 show a sequence wherein one embodiment shows a Client 22,24,29 (FIG. 7) that may not have the ability to adjust luminance on its own and therefore requires the Server 12 (FIG. 7) (or a CDN) to deliver a pre-processed image. In this case, the image may already be stored on the server in pre-processed form which causes this version in step 104 to be delivered. Alternately, if the particular version is not pre-stored, the Server 12 (FIG. 7) may use Asset Profile 2, 3, 4 (FIG. 7) to adjust luminance “on the fly” using the unprocessed image, Original Image 69 (FIG. 7). This is shown in the sequence path of 106, 107 and 108 in FIG. 10.

As shown in the flowchart entitled Serving C, steps 110-113 illustrates an embodiment wherein a Client 22, 24, 29 (FIG. 7) requests only Asset Profiles 2, 3, 4 (FIG. 7). In this case the client is capable of adjusting luminance with its own CPU 18, 25 (FIG. 7) by operating on the unprocessed image Original Image 69 (FIG. 7).

Therefore, as shown in FIG. 10, certain embodiments of the invention allow clients, in conjunction with servers to select the optimal method for achieving the best and most efficient method for generating and displaying and image optimized for luminance. If a client does not possess the compute capability necessary to “self-adjust” its luminance for optimal viewing, then it can request from a server a version of an image to best match the clients display environment. However, if a client does have the capability to compute for itself, the necessary luminance adjustments for an image (or sequence of images), then the client is free to request from a server (CDN) an original (unprocessed) copy of the image(s) and compute the adjustments “on the fly” from either pre-computed Asset Profiles 2,3,4 (FIG. 7) or from the clients own algorithms. It is this flexibility of image luminance management that allows both old and new devices to achieve a similar viewing outcome.

Delivery

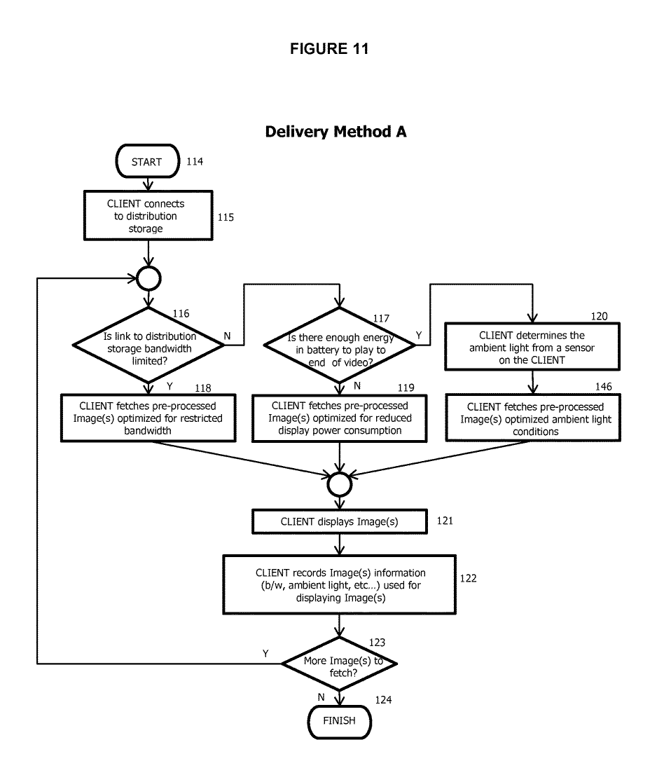

In another embodiment, the delivery of specific images to Clients 22, 24, 29 (FIG. 7) from the Server 12 (FIG. 7) (CDN) is controlled by the clients. In other words, the clients, from their current situation (such as, for example, battery power, ambient light, bandwidth) take decisions about the particular image(s) within a DRC Image Asset 6 (FIG. 7) to present to the viewer 71,72 (FIG. 7) of the Client 22,24,29 (FIG. 7). As shown in Delivery Method A in FIG. 11, steps 114-124 illustrate an embodiment of how a client without an ability to locally compute image luminance changes can determine the most optimal image to retrieve from the Server 12 (CDN) (FIG. 7) for its prevailing conditions. In this embodiment, the client first checks at step 116 to see if the Communication Link 12,23 (FIG. 7) can support a high enough bandwidth for delivery of a nuanced image insofar as luminance. If the Communication Link 12,23 (FIG. 7) is not capable, then a version of the image within the DRC Image Asset 6 (FIG. 7) is selected at step 118 and displayed at step 121. At step 117, if bandwidth is not an issue, then the client determines whether or not battery energy is an issue. At step 119, if there is not enough battery power, an optimized image within DRC Image Asset 6 (FIG. 7) is fetched and displayed at step 121. In this particular embodiment, a final determination is made as to the ambient light level at step 120, and if appropriate, a version of the image capable of addressing current ambient light conditions is fetched at step 146 and displayed at step 121. The invention does not specify or restrict the algorithm for choosing the best image based upon prevailing conditions of the client. Whatever image was selected and displayed from DRC Image Asset 6 (FIG. 7), its information (e.g., type or settings) may be recorded at step 122 and stored for later recovery and analysis by the Client Processor 63 (FIG. 7).

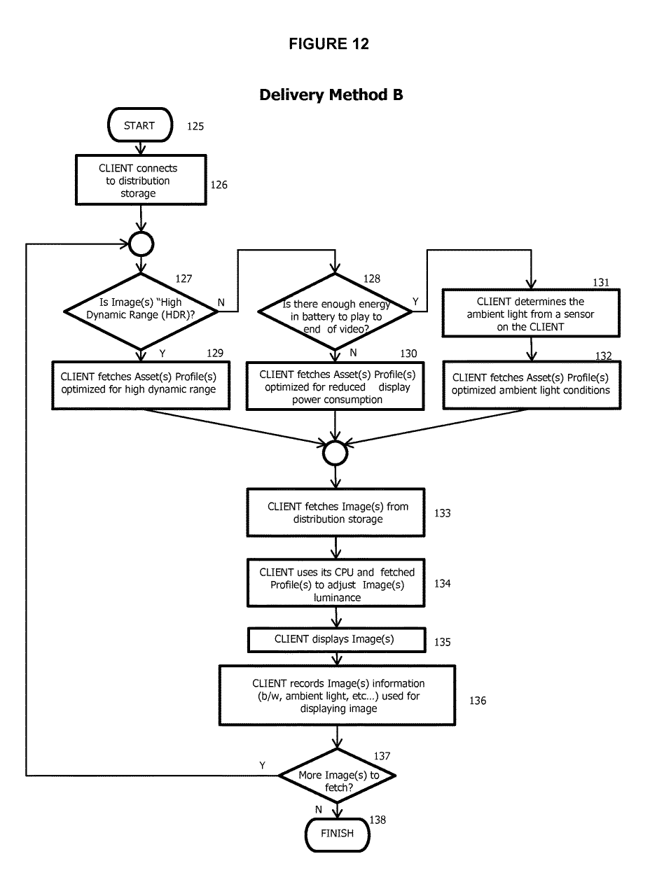

As shown in FIG. 12, a flowchart Delivery Method B having steps 125-138 illustrates an embodiment having a client with a CPU capable of processing luminance is illustrated. Unlike Delivery Method A, the first decision in step 127 is whether the version of the image exists that is high dynamic range (HDR). HDR content displayed on a standard dynamic range (SDR) display needs to be adjusted to better match the SDR display technology. Also unlike Delivery Method A, Asset DRC Profile(s) 11 (FIG. 7) are fetched at steps 129, 130, 131 and not the pre-processed versions DRC Images 7,8,9 (FIG. 7) of the requested image(s). With the correct Asset Profile available, the client fetches the Original Image 69 (FIG. 7) at step 133 and uses its CPU to adjust the luminance at steps 134 and 135. Whatever Asset Profile was selected and utilized from DRC Image Asset 6 (FIG. 7), its information (e.g., type or settings, etc. . . . ) may be recorded at step 122 and stored for later recovery and analysis by the Client Processor 63 (FIG. 7).

Client Analysis

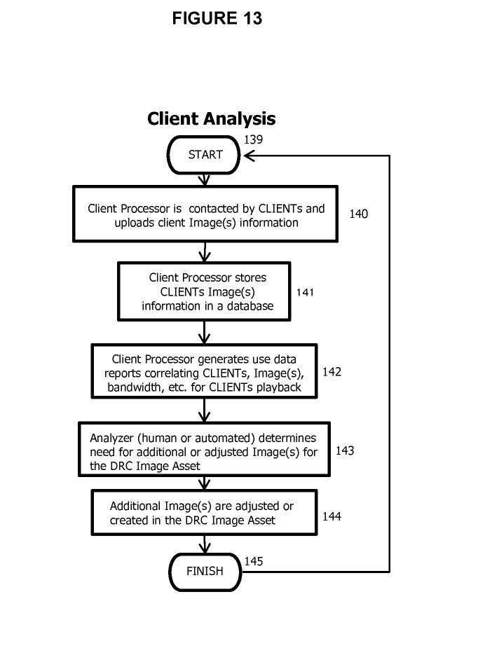

As shown in FIG. 13, a flowchart sequence at steps 139-145 illustrates the use of a Client Processor 63 (FIG. 7), connected through a network or Distribution Link 14 (FIG. 7) used for the aggregation and analysis of use luminance use data from Clients 22,24, 29 (FIG. 7). In one embodiment, the Client Processor 63 (FIG. 7) is contacted by clients at step 140 and information collected by Clients 22,24, 29 (FIG. 7) related to the selection and displaying of images is uploaded. While this embodiment describes clients contacting the Client Processor 63 (FIG. 7), other embodiments allow for the Client Processor 63 (FIG. 7) to contact the Clients 22,24, 29 (FIG. 7). The frequency of uploads is not specified but can be determined by the clients or the client processor. Once the client information has been uploaded, it is stored in a database 73 (FIG. 7) within the Client Processor 63 (FIG. 7) at step 141. After client data has been uploaded, the Client Processor 63 (FIG. 7) creates reports at step 142 that correlates the use data among selected or wide spread clients. These reports may be specific, but not limited, to bandwidths used, display types, image resolutions, device types and CPU performance. Once correlated data is available, analysis of the reports is made either automatically by the Client Processor 63 (FIG. 7) or by an Operator 70 (FIG. 7) at step 143. The result of the analysis can result in the modification of specific DRC Images 7,8,9 and DRC Profiles 11 (FIG. 7) within a DRC Image Asset 6 (FIG. 7) or the generation of new images which will be added to the DRC Image Asset 6 (FIG. 7) to account for an improved luminance profile option. The ability for the DRC image processing system to gather feedback from clients and make adjustments and additions to the DRC Image Asset 6 is a further embodiment of the invention. As new devices and displays make their entry into the marketplace, the DRC image processing system adapts and helps bridge the gap between new and old content and display technologies.

Other embodiments of the invention will be apparent to those skilled in the art from consideration of the specification and practice of the invention disclosed herein. It is intended that the specification and examples be considered as exemplary only, with a true scope and spirit of the invention being limited only by the following claims.

What is claimed is:

1. A method for adjusting luminance of one or more digital images for use by a client connected to a network, comprising:
selecting by an operator one or more pre-determined input parameters for a dynamic range compression (DRC) processor that adjusts the luminance of the one or more digital images for use by the client display;
generating one or more adjusted images by said DRC processor, wherein said one or more adjusted images comprise an image asset; and
loading the image asset to one or more storage devices.

2. The method of claim 1, wherein the DRC processor generates one or more adjusted image profiles comprising the image asset.

3. The method of claim 1, wherein the operator is selected from the group consisting of human and machine.

4. The method of claim 1, wherein the adjusted image is optimized for one or more pre-determined setting parameters.

5. The method of claim 2, wherein the adjusted image profile is optimized for one or more pre-determined setting parameters.

6. The method according to claim 4 or 5, wherein the one or more pre-determined setting parameters are selected from at least one of the group including
client display type,
client display resolution,
client display dynamic range,
power available for supplying the client display,
client power consumption,
network bandwidth,
intensity levels of ambient light around the client display,
image encoding method and
image file type.

7. The method of claim 1, wherein the image asset includes an unadjusted image and one or more adjusted image profiles with tags output by the DRC processor.

8. The method of claim 6, wherein the client display type is selected from the group consisting of cathode ray tube, liquid crystal, front projection display, rear projection, plasma, light emitting diode (LED), organic LED (OLED), 3-dimensional and holographic.

9. The method of claim 6, wherein the image encoding is selected from the group consisting of JPEG, MPEG, H.264, H.265 and VP9.

10. The method of claim 6 wherein the image file type is selected from the group consisting of high dynamic range (HDR) and standard dynamic range (SDR).

11. The method of claim 1, wherein the storage is a Content Distribution Network (CDN).

12. The method of claim 1, wherein the digital image is a frame of video data.

13. The method of claim 6, wherein the adjusted image is arranged such that the luminance of the client display conserves the client power.

14. The method of claim 6, wherein the adjusted image is arranged such that the luminance of the client display conserves network bandwidth.

15. The method of claim 12, wherein the adjusted digital image is selected by a client in real-time as the pre-determined condition parameters vary with time.

16. A method for adjusting luminance on a display for a client connected to a network, comprising:
receiving from the network one or more image assets, wherein the image assets comprise one or more adjusted digital images processed by a DRC processor; and
selecting the adjusted digital image from the image asset that is optimized for use by the client display; and
displaying the adjusted digital image on the client display.

17. A method of claim 16, wherein the selecting of the adjusted digital image is based on one or more pre-determined condition parameters from at least one of the group including
client display type,
client display resolution,
client display dynamic range,
power available for supplying the client display,
client power consumption,
network bandwidth,
intensity levels of ambient light around the client display,
image encoding method and
image file type.

18. The method of claim 16, wherein the adjusted digital image is a frame of video data.

19. The method of claim 17, wherein the client selects the adjusted digital image from the image asset such that the luminance of the client display conserves the client power.

20. The method of claim 17, wherein the client selects the adjusted digital image from the image asset such that the luminance of the client display conserves network bandwidth.

21. The method of claim 17, wherein the client selects the adjusted digital image from the image asset for the client display type and intensity levels of ambient light around the client display.

22. The method of claim 16, wherein the image asset further comprises one or more adjusted image profiles with tags output by a DRC processor and an unadjusted digital image.

23. The method of claim 22, wherein the client selects one adjusted image profile from the image asset and processes locally the unadjusted digital image for the client display using the one or more pre-determined condition parameters.

24. The method of claim 22, wherein the client transmits over the network to a remote processor its condition over time as recorded according to the one or more pre-determined condition parameters.

25. The method of claim 24, wherein the remote processor transmits to the client the optimum adjusted digital image to display for the one or more pre-determined condition parameters.

26. The method of claim 24, wherein the remote processor is shared by two or more clients.

27. The method of claim 17, wherein the adjusted digital image is selected by a client in real-time as the pre-determined condition parameters vary with time.

28. The method of claim 22, wherein the client uses a local DRC processor to create a local adjusted digital image using the unadjusted digital image received from the network.

29. A method for storing and transmitting digital images for controlling luminance on a display for a client connected to a network, comprising:
receiving from one or more DRC processors one or more image assets, wherein the image assets comprise one or more adjusted digital images processed by the one or more DRC processors; and
storing the adjusted image assets on one or more storage devices connected to the network.

30. A method of claim 29, wherein the adjusted digital image is stored based on one or more pre-determined condition parameters from at least one of the group including
client display type,
client display resolution,
client display dynamic range,
power available for supplying the client display,
client power consumption,
network bandwidth,
intensity levels of ambient light around the client display,
image encoding method and
image file type.

31. The method of claim 29, wherein the adjusted digital image is a frame of video data.

32. The method of claim 29, wherein the image asset further comprises one or more adjusted image profiles with tags output by the DRC processor and an unadjusted digital image.

33. The method of claim 30, wherein the storage device receives from the client one or more pre-determined condition parameters and the storage device transmits to the client the adjusted digital image based on said pre-determined condition parameters.

34. The method of claim 32, wherein the storage device receives from the client a command to send the client the one or more adjusted image profiles and the unadjusted digital image.

35. The method of claim 32, wherein the storage device receives from the client a command to send the client only the unadjusted digital image.

36. The method of claim 29, wherein the one or more storage devices comprise a Content Distribution Network (CDN).

37. The method of claim 29, wherein the one or more storage devices are servers.

38. The method of claim 29, wherein the one or more storage devices transmits to an operator of a DRC processor a data set from at least one of the group including
client identity,
adjusted images selected by clients in the aggregate and
pre-determined condition parameters from the clients in the aggregate.

39. A storage system for controlling luminance on a display for a client connected to a network, comprising one or more servers that receive processed image data from a DRC processor, wherein the one or more servers transmit over a network the processed image data to one or more clients with displays.

40. The system of claim 39, wherein the processed image data are stored on the servers according to on one or more pre-determined condition parameters from at least one of the group including
client display resolution,
client display dynamic range,
client display type,
power available for supplying the client display,
client power consumption,
network bandwidth,
intensity levels of ambient light around the client display,
image encoding and
image file type.

41. The system of claim 40, wherein the storage device transmits the processed image data to the client in real-time according to the pre-determined condition parameters transmitted to the storage device by the client.

42. The system of claim 40, wherein the DRC processor is local to the server.
